(19) United States
(12) Patent Application Publication
(10) Pub. No.: US 2024/0198141 A1
(43) Pub. Date: Jun. 20, 2024

(54) HEAD WEARABLE AIR PURIFIER

(71) Applicant: Dyson Technology Limited, Wiltshire (GB)

(72) Inventors: Duncan Jack PATTULLO, Bristol (GB); Mark Paul FOULGER, Bristol (GB)

(73) Assignee: Dyson Technology Limited, Wiltshire (GB)

(21) Appl. No.: 18/287,992

(22) PCT Filed: Apr. 25, 2022
(86) PCT No.: PCT/GB2022/051040

§ 371 Date: Oct. 23, 2023

(30) Foreign Application Priority Data
Apr. 26, 2021 (GB) 2105939.9

(51) Int. Cl. A62B 18/00; A62B 7/10; A62B 18/02; A62B 18/08

(52) U.S. Cl. CPC A62B 18/003; A62B 7/10; A62B 18/006; A62B 18/025; A62B 18/084

(57) ABSTRACT

A head wearable air purifier has a headgear, and an air purifier assembly supported by the headgear, the air purifier assembly having a filter and an airflow generator for generating an airflow through the filter. The head wearable air purifier has a nozzle assembly having an inlet aperture configured to receive a filtered airflow from the air purifier assembly, and an air outlet for emitting the filtered airflow from the nozzle assembly. The nozzle assembly includes a first end section connected to the headgear, a second end section connected to the headgear, and a midsection connected to the first end section and the second end section. The first end section has a first portion pivotally connected to the midsection about a first pivot axis, and a second portion pivotally connected to the first portion about a second pivot axis substantially orthogonal to the first pivot axis, the second portion connected to the headgear.

### FIELD OF THE INVENTION

The present invention relates to a head wearable air purifier, and a nozzle assembly for a head wearable air purifier.

### BACKGROUND OF THE INVENTION

Air pollution is an increasing problem and a variety of air pollutants have known or suspected harmful effects on human health. The adverse effects that can be caused by air pollution depend upon the pollutant type and concentration, and the length of exposure to the polluted air. For example, high air pollution levels can cause immediate health problems such as aggravated cardiovascular and respiratory illness, whereas long-term exposure to polluted air can have permanent health effects such as loss of lung capacity and decreased lung function, and the development of diseases such as asthma, bronchitis, emphysema, and possibly cancer.

In locations with particularly high levels of air pollution, many individuals have recognised the benefits of minimising their exposure to these pollutants and have therefore taken to wearing face masks with the aim of filtering out at least a portion of the pollutants present in the air before it reaches the mouth and nose. There have also been various attempts to develop air purifiers that can be worn by the user but that do not require the wearer's mouth and nose to be covered. For example, there are various designs for wearable air purifiers that are worn around the neck of the wearer and that create a jet of air that is directed upwards towards the wearer's mouth and nose. There is a general desire for wearable air purifiers to be comfortable for a wearer in use.

### SUMMARY OF THE INVENTION

According to a first aspect of the present invention there is provided a head wearable air purifier comprising: a headgear; an air purifier assembly supported by the headgear, the air purifier assembly comprising a filter and an airflow generator for generating an airflow through the filter; and a nozzle assembly comprising an inlet aperture configured to receive a filtered airflow from the air purifier assembly, and an air outlet for emitting the filtered airflow from the nozzle assembly; wherein the nozzle assembly comprises a first end section connected to the headgear, a second end section connected to the headgear, and a midsection connected to the first end section and the second end section, the first end section comprises a first portion pivotally connected to the midsection about a first pivot axis, and a second portion pivotally connected to the first portion about a second pivot axis substantially orthogonal to the first pivot axis, the second portion connected to the headgear.

The head wearable air purifier according to the first aspect of the present invention may be advantageous as the first end section comprises a first portion pivotally connected to the midsection about a first pivot axis, and a second portion pivotally connected to the first portion about a second pivot axis substantially orthogonal to the first pivot axis. In particular, this may provide the nozzle assembly with at least two degrees of freedom of motion, with pivoting of components of the nozzle assembly able to take place about both the first and second pivot axes.

As the first portion of the first end section is pivotally connected to the midsection about a first pivot axis, the midsection may be able to move relative to the first end section, which may provide for increased flexibility in the arrangement of the nozzle assembly, thereby allowing for increased wearer comfort, and an arrangement in which the nozzle assembly is located closely relative to a face of a wearer in use. Such movability may allow the nozzle assembly to be adapted for a face of an individual wearer, for example, to closely conform to a face of an individual wearer.

As the second portion of the first end section is pivotally connected to the first portion of the first end section, the second portion may be able to move relative to the first portion, which may provide for increased flexibility in the arrangement of the nozzle assembly, thereby allowing for increased wearer comfort, and an arrangement in which the nozzle assembly is located closely relative to a face of a wearer in use. Such movability may allow the nozzle assembly to be adapted for a face of an individual wearer, for example, to closely conform to a face of an individual wearer.

As the second pivot axis is substantially orthogonal to the first pivot axis, movement in two different directions may be enabled, which may provide increased flexibility relative to an arrangement where the first and second pivot axes are substantially parallel to one another.

The first and second end sections may be connected to the headgear directly, for example with no intervening components therebetween, or may be connected to the headgear indirectly, for example with one or more intervening components therebetween. The first and second end sections may be connected to the air purifier assembly, for example to first and second portions of the air purifier assembly. The air purifier assembly may comprise a purifier assembly housing supported by the headgear, and the first and second end sections may be connected to the purifier assembly housing.

The air outlet of the nozzle assembly may comprise a final component of the head wearable air purifier through which filtered airflow travels before being emitted from the head wearable purifier towards a wearer. For example, there may be no components of the head wearable air purifier downstream of the air outlet of the nozzle assembly through which filtered airflow passes in use, and filtered airflow may be emitted from the air outlet, and hence from the nozzle assembly, toward the mouth and nasal region of a wearer in use.

The first end section may be connected to a first side of the headgear, and the second end section may be connected to a second side of the headgear, the second side opposite to the first side. The first side of the headgear may be opposite to the second side of the headgear, for example diametrically opposite, when the head wearable air purifier is located on a head of a wearer in use. The nozzle assembly may be configured such that, in use, with the head wearable air purifier located on a head of a wearer, the nozzle assembly extends in front of a face of the wearer, for example such that the air outlet is located in a region of a mouth and/or lower nasal region of the wearer. The nozzle assembly may be configured such that, in use, the nozzle assembly extends in front of a face of the wearer without contacting the face of the wearer. This may provide an arrangement with increased comfort for the wearer, for example relative to an arrangement where the nozzle assembly contacts a face of a wearer in use. The nozzle assembly may be generally elongate and arcuate in form. The air outlet may be substantially centrally located along the nozzle assembly, for example located centrally upon the midsection.

The first portion of the first end section may be pivotally connected to the midsection such that rotation of the midsection relative to the first end section is enabled in a plane substantially parallel to a transverse plane of a wearer of the head wearable air purifier in use, for example a plane substantially orthogonal to a coronal plane of the wearer and substantially orthogonal to a sagittal plane of the wearer. This may enable motion of the midsection relative to the first end section in a generally horizontal direction across the face of a wearer in use.

The first portion of the first end section may be pivotally connected to the midsection such that internal and external rotation of the midsection relative to a midline of the headgear is enabled, for example relative to an axis which bisects the headgear and runs parallel to a longitudinal axis of a wearer.

The first portion of the first end section may be rotatable through a range of no more than 45 degrees, or no more than 30 degrees, relative to the midsection. This may provide sufficient rotation to account for variations in positioning of the headgear when positioned on the head of a wearer in use, whilst limiting any restrictions placed on an airflow path through the first end section.

The second portion of the first end section may be pivotally connected to the first portion of the first end section such that rotation of the second portion relative to the first portion is enabled in a plane substantially parallel to a coronal plane of a wearer of the head wearable air purifier in use, for example a plane substantially orthogonal to a transverse plane of the wearer and substantially orthogonal to a sagittal plane of the wearer. This may enable variation of positioning of the headgear when positioned on the head of a wearer in use to be accounted for. The second portion of the first end section may be pivotally connected to the first portion of the first end section such that rotation of the second portion relative to an axis extending orthogonal to a longitudinal axis of a wearer in use is enabled.

The second portion of the first end section may be rotatable through a range of no more than 20 degrees, or no more than 10 degrees, relative to the first portion of the first end section. This may provide sufficient rotation to account for variations in positioning of the headgear when positioned on the head of a wearer in use, whilst limiting any restrictions placed on an airflow path through the first end section.

A duct, for example a flexible duct, may extend through the first end section, for example through the first and second portions of the first end section, and filtered airflow may flow through the duct in use. This may minimise leakage of filtered airflow through the pivotally connected first and second portions relative to, for example, an arrangement which simply has an aperture through the first end section. The pivotal connection of the second portion of the first end section to the first portion of the first end section may be located inwardly of the duct when the head wearable air purifier is located on a head of a wearer in use.

The second portion of the first end section may be pivotally connected to the headgear. This may allow for relative movement of the first end section, and hence the nozzle assembly, relative to the headgear. This may provide for increased flexibility in the arrangement of the nozzle assembly, and may, for example, enable the nozzle assembly to be dipped relative to the headgear. The second portion of the first end section may be rotatable through a range of no more than 60 degrees, or no more than 40 degrees, relative to the headgear.

The second portion may be pivotally connected to the headgear about a third pivot axis substantially orthogonal to the first pivot axis and substantially orthogonal to the second pivot axis. This may provide for increased flexibility in the arrangement of the nozzle assembly. The second portion may pivotally connected to the headgear such that rotation of the second portion relative to the headgear is enabled in a plane substantially parallel to a sagittal plane of a wearer of the head wearable air purifier in use, for example a plane substantially orthogonal to a transverse plane of the wearer and substantially orthogonal to a coronal plane of the wearer. This may enable rotation of the nozzle assembly in an up-down direction of the wearer in use. The second portion of the first end section may be pivotally connected to the headgear such that rotation of the second portion relative to an axis extending orthogonal to a longitudinal axis of a wearer is enabled.

The second portion may be releasably connected to the headgear, for example such that the nozzle assembly is releasable and at least partially separable from the headgear. A releasable connection may facilitate cleaning of the nozzle assembly. The second portion may comprise a magnetic attachment feature for releasably attaching to a corresponding magnetic attachment feature of the headgear. A magnetic attachment feature may provide a relatively simple yet strong connection.

The second end section may comprise a first portion pivotally connected to the midsection about a fourth pivot axis, and a second portion pivotally connected to the first portion about a fifth pivot axis substantially orthogonal to the fourth pivot axis, the second portion of the second end section connected to the headgear. As the first portion of the second end section is pivotally connected to the midsection about a fourth pivot axis, the midsection may be able to move relative to the second end section, which may provide for increased flexibility in the arrangement of the nozzle assembly, thereby allowing for increased wearer comfort, and an arrangement in which the nozzle assembly is located closely relative to a face of a wearer in use. Such movability may allow the nozzle assembly to be adapted for a face of an individual wearer, for example, to closely conform to a face of an individual wearer.

As the second portion of the second end section is pivotally connected to the first portion of the second end section, the second portion may be able to move relative to the first portion, which may provide for increased flexibility in the arrangement of the nozzle assembly, thereby allowing for increased wearer comfort, and an arrangement in which the nozzle assembly is located closely relative to a face of a wearer in use. Such movability may allow the nozzle assembly to be adapted for a face of an individual wearer, for example, to closely conform to a face of an individual wearer.

As the fifth pivot axis is substantially orthogonal to the fourth pivot axis, movement in two different directions may be enabled, which may provide increased flexibility relative to an arrangement where the fourth and fifth pivot axes are substantially parallel to one another.

The first portion of the second end section may be pivotally connected to the midsection such that rotation of the midsection relative to the second end section is enabled in substantially the same plane as rotation of the midsection relative to the first end section.

The first portion of the second end section may be pivotally connected to the midsection such that rotation of the midsection relative to the second end section is enabled in a plane substantially parallel to a transverse plane of a wearer of the head wearable air purifier in use, for example a plane substantially orthogonal to a coronal plane of the wearer and substantially orthogonal to a sagittal plane of the wearer.

The first portion of the second end section may be pivotally connected to the midsection such that internal and external rotation of the midsection relative to a midline of the headgear is enabled, for example relative to an axis which bisects the headgear and runs parallel to a longitudinal axis of a wearer.

The first portion of the second end section may be rotatable through a range of no more than 45 degrees, or no more than 30 degrees, relative to the midsection. This may provide sufficient rotation to account for variations in positioning of the headgear when positioned on the head of a wearer in use, whilst limiting any restrictions placed on an airflow path through the first end section.

The second portion of the second end section may be pivotally connected to the first portion of the second end section such that rotation of the second portion of the second end section relative to the first portion of the second end section is enabled in substantially the same plane as rotation of the second portion of the first end section relative to the first portion of the first end section. The second portion of the second end section may be pivotally connected to the first portion of the second end section such that rotation of the second portion of the second end section relative to the first portion of the second end section is enabled in a plane substantially parallel to a coronal plane of a wearer of the head wearable air purifier in use, for example a plane substantially orthogonal to a transverse plane of the wearer and substantially orthogonal to the sagittal plane of a wearer. The second portion of the second end section may be pivotally connected to the first portion of the second end section such that rotation of the second portion of the second end section relative to an axis extending orthogonal to a longitudinal axis of a wearer in use is enabled.

The second portion of the second end section may be rotatable through a range of no more than 20 degrees, or no more than 10 degrees, relative to the first portion of the second end section. This may provide sufficient rotation to account for variations in positioning of the headgear when positioned on the head of a wearer in use, whilst limiting any restrictions placed on an airflow path through the second end section.

A duct, for example a flexible duct, may extend through the second end section, for example through the first and second portions of the second end section, and filtered airflow may flow through the duct in use. This may minimise leakage of filtered airflow through the pivotally connected first and second portions of the second end section relative to, for example, an arrangement which simply has an aperture through the second end section. The pivotal connection of the second portion of the second end section to the first portion of the second end section may be located inwardly of the duct when the head wearable air purifier is located on a head of a wearer in use.

The second portion of the second end section may be pivotally connected to the headgear. This may allow for relative movement of the first end section, and hence the nozzle assembly, relative to the headgear. This may provide for increased flexibility in the arrangement of the nozzle assembly, and may, for example, enable the nozzle assembly to be dipped relative to the headgear. The second portion of the second end section may be rotatable through a range of no more than 60 degrees, or no more than 40 degrees, relative to the headgear.

The second portion of the second end section may be pivotally connected to the headgear about a sixth pivot axis substantially orthogonal to the fourth pivot axis and substantially orthogonal to the fifth pivot axis. This may provide for increased flexibility in the arrangement of the nozzle assembly. The second portion of the second end section may be pivotally connected to the headgear such that rotation of the second portion of the second end section relative to the headgear is enabled in a plane substantially parallel to a sagittal plane of a wearer of the head wearable air purifier in use, for example a plane substantially orthogonal to a transverse plane of the wearer and substantially orthogonal to a coronal plane of the wearer. This may enable rotation of the nozzle assembly in an up-down direction of the wearer in use. The second portion of the second end section may be pivotally connected to the headgear such that rotation of the second portion of the second end section relative to an axis extending orthogonal to a longitudinal axis of a wearer is enabled.

The second portion of the second end section may be releasably connected to the headgear, for example such that the nozzle assembly is releasable and at least partially separable from the headgear. A releasable connection may facilitate cleaning of the nozzle assembly. The second portion of the second end section may comprise a magnetic attachment feature for releasably attaching to a corresponding magnetic attachment feature of the headgear. A magnetic attachment feature may provide a relatively simple yet strong connection.

The first portion of the first end section may be pivotally connected to the midsection by at least one hinge, for example by a first hinge located at a first side of the first portion and a second hinge located at a second side of the first portion opposite to the first side of the first portion.

The first portion of the second end section may be pivotally connected to the midsection by at least one hinge, for example by a third hinge located at a first side of the first portion and a fourth hinge located at a second side of the first portion opposite to the first side of the first portion.

The first portion of the first end section and the second portion of the first end section may comprise cooperating projections and channels that pivotally connect the first portion of the first end section to the second portion of the first end section. For example, one of the first and second portions of the first end section may comprise a channel that receives a corresponding projection of the other of the second and first portions of the first end section such that the projection is slidable within the channel to cause relative rotation between the first and second portions of the first end section. An extent of the channel may limit relative rotation between the first and second portions of the first end section.

The first and second portions of the first end section may each comprise projections and recesses, for example such that recesses of the first portion receive projections of the second portion, and recesses of the second portion receive projections of the first portion.

The first portion may comprise a generally cylindrical protrusion, with an annular channel and first and second side channels formed therein. Portions of the generally cylindrical protrusion that extend outwardly relative to the annular channel and first and second side channels may be considered projections. The first and second side channels may be configured to receive corresponding first and second side projections of the second end portion. The generally cylindrical protrusion may comprise a lip configured to be received within a corresponding receiving channel of the second portion.

The second portion of the first end section may comprise first and second parts attached to one another. Forming the second portion of the first end section of first and second parts may facilitate manufacture, for example where the first portion of the first end section and the second portion of the first end section comprise cooperating projections and channels that pivotally connect the first portion of the first end section to the second portion of the first end section.

The pivotal connection of the second portion of the second end section to the first portion of the second end section may comprise substantially the same form as the pivotal connection of the second portion of the first end section to the first portion of the first end section.

The first portion of the second end section and the second portion of the second end section may comprise cooperating projections and channels that pivotally connect the first portion of the second end section to the second portion of the second end section. For example, one of the first and second portions of the second end section may comprise a channel that receives a corresponding projection of the other of the second and first portions of the second end section such that the projection is slidable within the channel to cause relative rotation between the first and second portions of the second end section. An extent of the channel may limit relative rotation between the first and second portions of the second end section.

The first and second portions of the second end section may each comprise projections and channels, for example such that channels of the first portion receive projections of the second portion, and channels of the second portion receive projections of the first portion. The first portion may comprise a generally cylindrical protrusion, with an annular channel and first and second side channels formed therein. Portions of the generally cylindrical protrusion that extend outwardly relative to the annular channel and first and second side channels may be considered projections. The first and second side channels may be configured to receive corresponding first and second side projections of the second end portion. The generally cylindrical protrusion may comprise a lip configured to be received within a corresponding receiving channel of the second portion.

The second portion of the second end section may comprise first and second parts attached to one another. Forming the second portion of the second end section of first and second parts may facilitate manufacture, for example where the first portion of the second end section and the second portion of the second end section comprise cooperating projections and channels that pivotally connect the first portion of the second end section to the second portion of the second end section.

The airflow generator and filter may be configured to provide filtered airflow to the first end section of the nozzle assembly in use. Thus filtered airflow may pass through the first end section of the nozzle assembly, through the midsection of the nozzle assembly, and through the air outlet of the nozzle assembly in use. The air purifier assembly may comprise a further airflow generator and a further filter configured to provide a further filtered airflow to the second end section of the nozzle assembly in use. Provision of filtered airflow through both the first and second end sections may provide a relatively even flow distribution at both sides of the air outlet.

Pivotal connections of the nozzle assembly may be located outside of filtered airflow through the nozzle assembly in use, for example with the pivotal connection between the first portion of the first end section and the midsection, and the pivotal connection between the second portion of the first end section and the first portion of the first end section, located outside of filtered airflow through the nozzle assembly in use. Thus pivotal connections may not provide a flow obstruction to filtered airflow through the nozzle assembly in use, which may decrease turbulence of filtered airflow through the nozzle assembly in use compared to, for example, an arrangement where a pivotal connection is located within filtered airflow.

According to a second aspect of the present invention there is provided a nozzle assembly for a head wearable air purifier, the nozzle assembly comprising an inlet aperture for receiving an airflow, an air outlet for emitting the airflow from the nozzle assembly, a first end section for connection to a headgear, a second end section for connection to a headgear, and a midsection connected to the first end section and the second end section, the first end section comprises a first portion pivotally connected to the midsection about a first pivot axis, and a second portion pivotally connected to the first portion about a second pivot axis substantially orthogonal to the first pivot axis, the second portion for connection to the headgear.

Optional features of aspects of the present invention may be equally applied to other aspects of the present invention, where appropriate.

### BRIEF DESCRIPTION OF THE DRAWINGS

FIG. 1 is a schematic front view of a head wearable air purifier according to the present invention;

FIG. 2 is a cross-sectional view of the head wearable air purifier of FIG. 1 with a nozzle assembly removed;

FIG. 3 is a schematic underside of the head wearable air purifier of FIG. 1 with the nozzle assembly detached;

FIG. 4 is a rear perspective view of the nozzle assembly of the head wearable purifier of FIG. 1;

FIG. 5 is an enlarged view of a first end section of the nozzle assembly of FIG. 4;

FIG. 6 is a partially exploded view of the first end section of FIG. 5;

FIG. 7 is a fully exploded view of the first end section of FIG. 5;

FIG. 8 is a rear view of a first portion of the first end section of FIG. 5 in isolation; and

FIG. 9 is a front view of a second portion of the first end section of FIG. 5 in isolation.

### DETAILED DESCRIPTION OF THE INVENTION

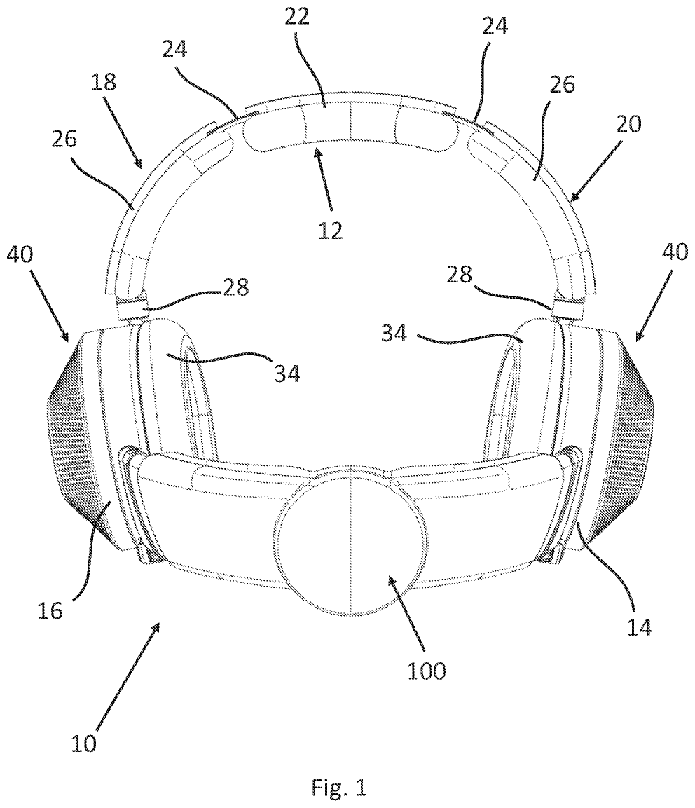

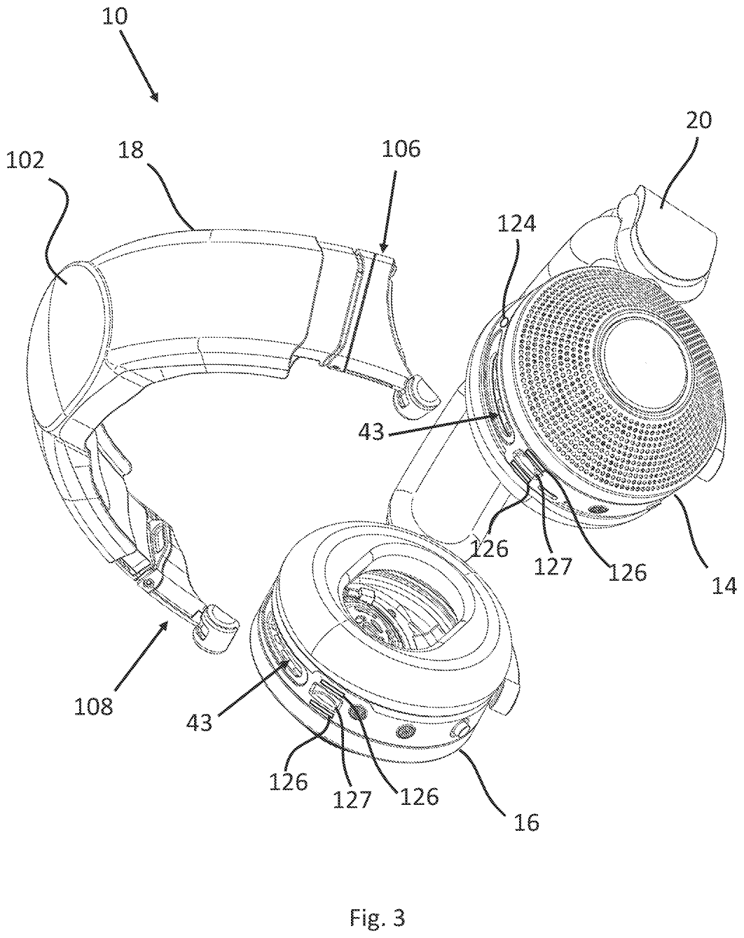

A head wearable air purifier, generally designated 10, is shown schematically in FIGS. 1, 2 and 3.

The head wearable air purifier 10 comprises a headgear 12, first 14 and second 16 purifier assembly housings, and a nozzle assembly 100.

The headgear 12 has the form of a headband, is generally elongate and arcuate in form, and is configured to overlie a top of a head of a wearer, and sides of the head of the wearer, in use. The headgear 12 has a first end portion 18, a second end portion 20, and a central portion 22. Each of the first 18 and second 20 end portions are connected to the central portion 22 by an extension mechanism. Each extension mechanism comprises an arm 24 that engages with teeth internal of the first 18 and second 20 end portions to form a ratchet mechanism that enables adjustment of the length of the headgear 12 by a wearer. To this end, the teeth, a spacing between the teeth and an opposing wall, or the arm 24 itself, may be sufficiently resilient to provide the required retention.

The first 18 and second 20 end portions of the headgear 12 each comprise a hollow housing 26. The hollow housing 26 defines a battery compartment for receiving one or more batteries therein. It will be appreciated that batteries may be removable from the hollow housing 26, or may be intended to be retained within the hollow housing 26 during normal use. Where the batteries are replaceable and intended to be removable from the hollow housing 26, the hollow housing 26 may, for example, comprise a releasable door or cover to enable access to the interior of the hollow housing 26. Where batteries are rechargeable and intended to be retained within the hollow housing 26 in normal use, the hollow housing 26, or indeed other components of the head wearable air purifier 10, may comprise at least one charge port to enable recharging of batteries.

The first 18 and second 20 end portions of the headgear 12 are connected to respective ones of the first 14 and second 16 purifier assembly housings. In some examples, the first 18 and second 20 end portions of the headgear 12 are connected to respective ones of the first 14 and second 16 purifier assembly housings such that relative movement is enabled between the first 18 and second 20 end portions of the headgear 12 and the respective first 14 and second 16 purifier assembly housings. As shown in FIG. 1, a gimbal arm 28 is used for such a connection, with swivel pins (not shown) located at either end of the gimbal arm 28, but it will be appreciated by a person skilled in the art that other forms of connection are possible. To enable electrical connection of batteries contained within the hollow housings 26 of the first 18 and second 20 end portions of the headgear to components internal of the first 14 and second 16 purifier assembly housings, the swivel pins 28 are hollow, for example to allow electrical wiring or the like to pass therethrough.

The first 14 and second 16 purifier assembly housings comprise ear cups such as those typically used for so-called “over-the-ear” headphones, which are generally hemi-spherical and hollow in form.

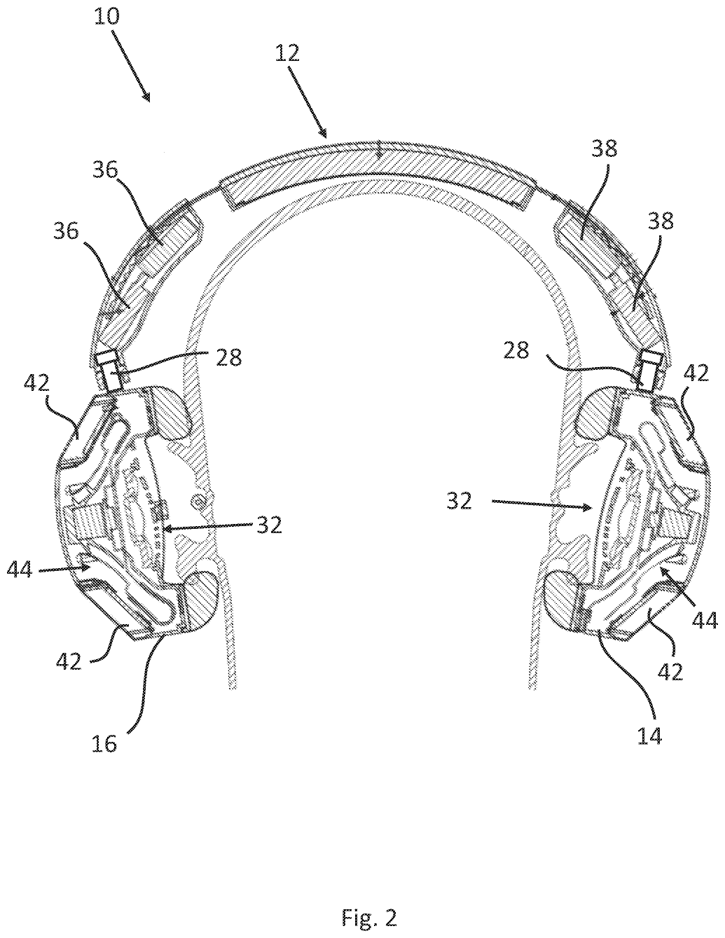

Each purifier assembly housing 14,16 houses a speaker assembly 32, as shown in FIG. 2, and comprises annular padding 34 configured to surround an ear of a wearer of the head wearable air purifier 10. Details of the speaker assembly 32 are not pertinent to the present invention, and so will not be described here for the sake of brevity, but it will be recognised by a person skilled in the art that any appropriate speaker assembly may be chosen. In use, the speaker assemblies 32 received within the first 14 and second 16 purifier assembly housings are configured to receive power from all of the batteries 36,38. Power transfer wiring (not shown) runs through the headgear 12 between the first 18 and second 20 end portions, for example through the central portion 22 and arms 24. Such an arrangement provides increased flexibility in power distribution between the speaker assemblies 32. In other embodiments the speaker assemblies 32 received within the first 14 and second 16 purifier assembly housings may be configured to receive power from batteries 36,38 disposed in respective ones of the first 18 and second 20 end portions of the headband. For example, a speaker assembly 32 received within the first purifier assembly housing 14 may be configured to be powered by the batteries 36 within the first end portion 18 of the headgear 12, whilst a speaker assembly 32 received within the second purifier assembly housing 16 may be configured to be powered by batteries 38 within the second end portion 20 of the headgear 12.

The first 14 and second 16 purifier assembly housings of the head wearable air purifier 10 further comprise ambient air inlets 40, filter assemblies 42, outlet apertures 43 and airflow generators 44.

The ambient air inlet 40 of each of the first 14 and second 16 purifier assembly housings comprises a plurality of apertures through which air may be drawn into the interior of the purifier assembly housing 14,16. Each filter assembly 42 is disposed within a respective purifier assembly housing 14,16 between the ambient air inlet 40 and a respective airflow generator 44. Each filter assembly 42 comprises a filter material chosen to provide a desired degree of filtration of air to be provided to a wearer in use.

The airflow generators 44 each comprise a motor driven impeller which draw air from the respective ambient air inlet 40, through the respective filter assembly 42, and output air through the respective outlet apertures 43, of the purifier assembly housings 14,16.

The airflow generators 44 in the first 14 and second 16 purifier assembly housings are configured to receive power from all of the batteries 36,38. Power transfer wiring (not shown) runs through the headgear 12 as described above in relation to the speaker assemblies 32. In other embodiments, the first purifier assembly housing may be configured to be powered by batteries 36 within the first end portion 18 of the headgear 12, whilst the airflow generator 44 in the second purifier assembly housing 16 may be configured to be powered by batteries 38 within the second end portion 20 of the headgear 10. This may allow at least one airflow generator 44 to be first in the event of failure of batteries 36,38 in one of the first 18 and second 20 end portions.

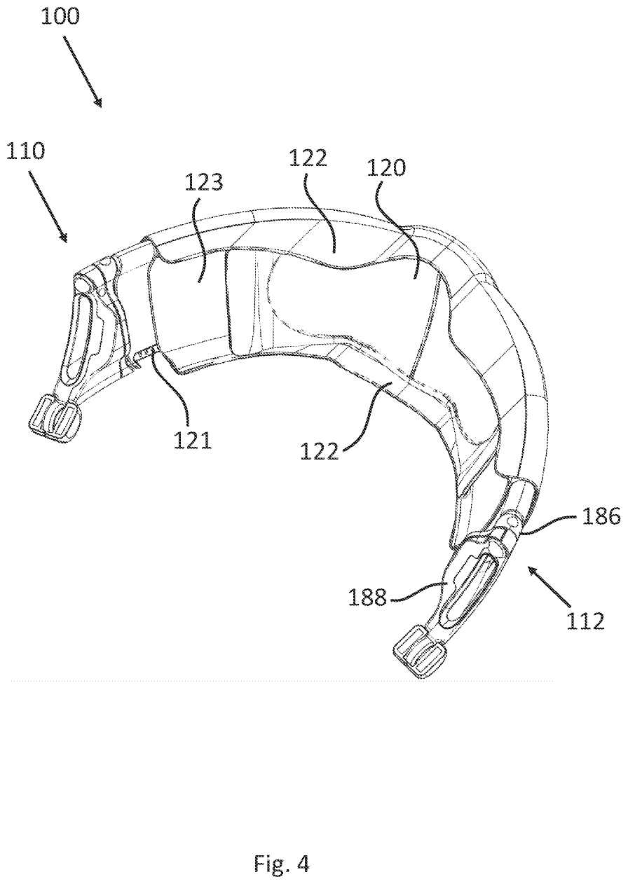

The nozzle assembly 100 is shown in isolation in FIG. 4.

The nozzle assembly 100 has first 106 and second 108 ends, and is curved between the first 106 and second 108 ends such that the nozzle assembly 100 is generally arcuate in form. The first 106 and second 108 ends comprise respective first 110 and second 112 end sections that connect to respective ones of the first 14 and second 16 purifier assembly housings, as will be described in more detail hereafter, and that connect to a midsection 102 of the nozzle assembly as will also be described in more detail hereafter.

When the nozzle assembly 100 is connected to the first 14 and second 16 purifier assembly housings, and the head wearable air purifier 10 is worn by a wearer, the nozzle assembly 100 is configured to extend in front of the face of the wearer, particularly the mouth and lower nasal region of the wearer, without contacting the face of the wearer.

The midsection 102 is generally hollow in form, and has an air outlet 120, which is defined by a mesh. Upper and lower surfaces of the midsection 102 comprise flow guides 122 that extend rearwardly, for example toward a void defined between the first 110 and second 112 end sections, and serve to prevent unfiltered air entering a breathing zone adjacent a mouth and nasal region of a face of a wearer in use, particularly in conditions where the head wearable air purifier 10 is worn outside in a cross wind. The flow guides 122 may be formed of a resiliently deformable material to allow for some deformation of the midsection and such that wearer comfort is provided in the event of accidental contact with a face of a wearer in use.

As shown in FIG. 4, the midsection 102 includes a main body 123 having a first end and a second end, and extension mechanisms 121 that connect the first end and second end of main body 123 to the respective first 110 and second 112 end sections of the nozzle assembly 100. The extension mechanisms 121 may take many forms, and may, for example, comprise a telescoping and/or ratchet mechanism that enables a length of the nozzle assembly 100 to be selectively increased or decreased by a wearer. The extension mechanisms 121 are hollow, and carry filtered airflow from the first 110 and second 112 end sections to the main body 123 of the midsection 102 in use.

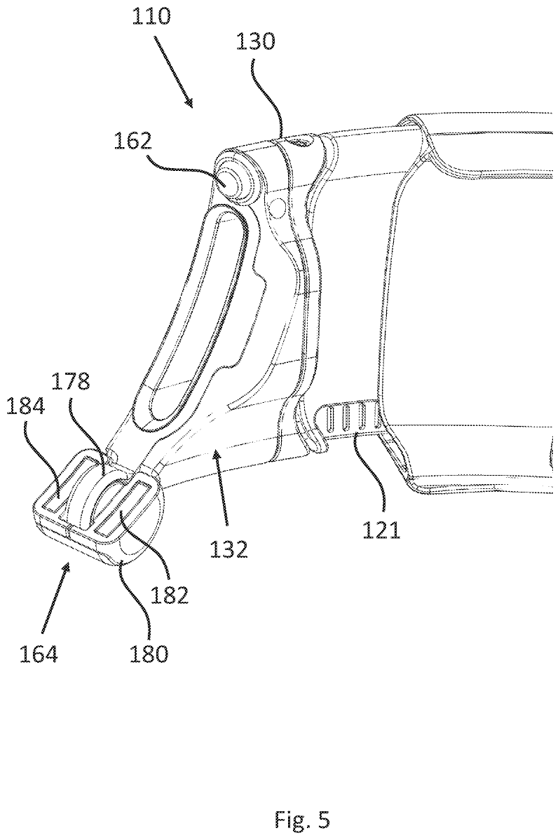

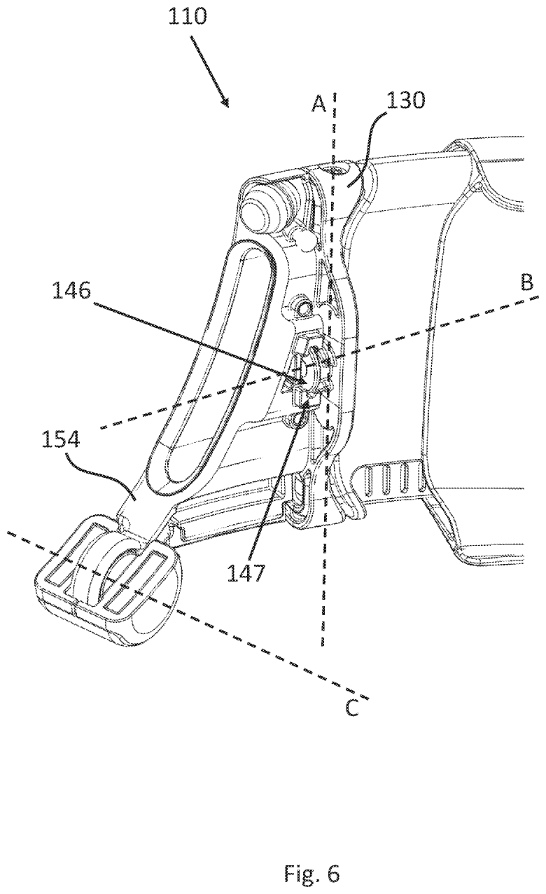

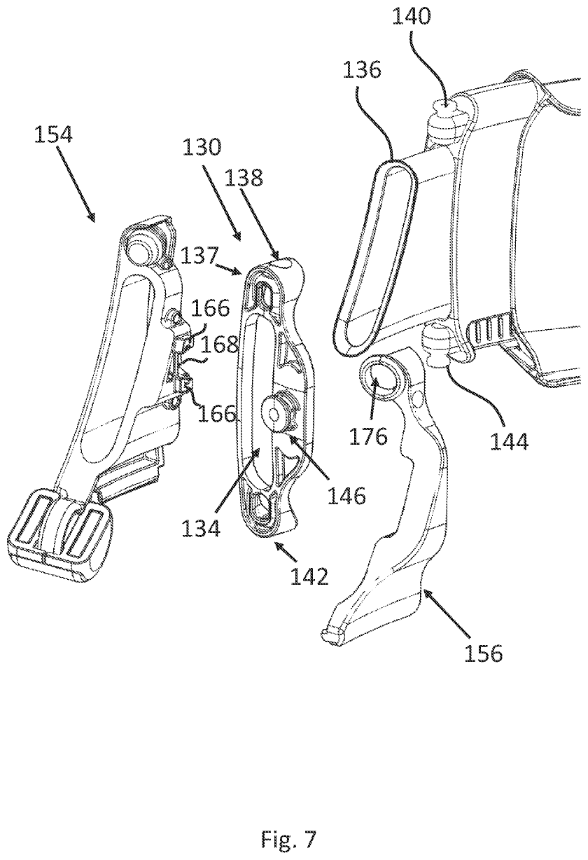

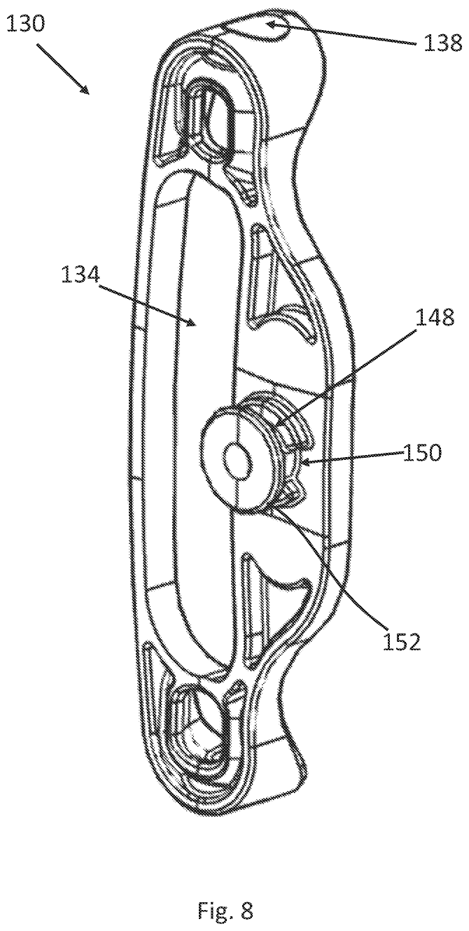

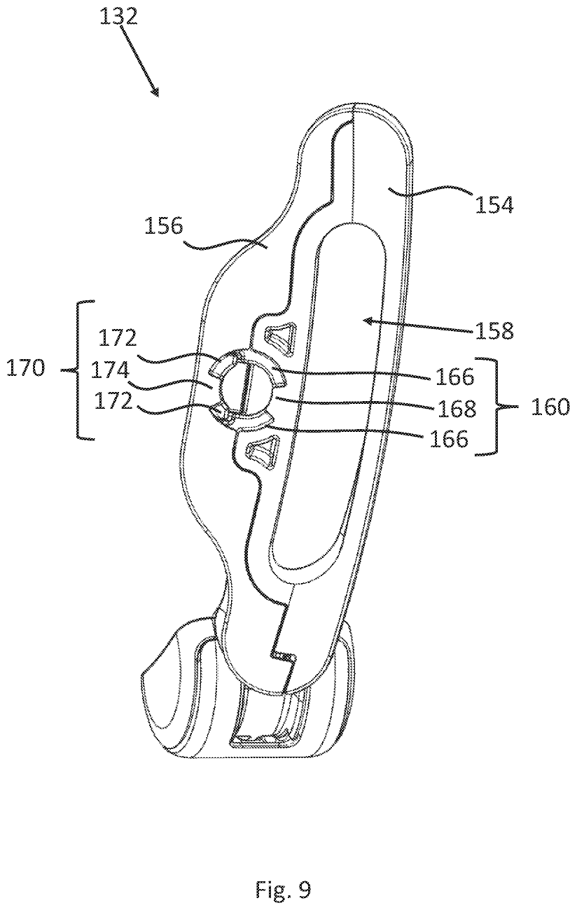

The first end section 110 is shown in isolation in FIG. 5, with individual components of the first end section 110 visible in the exploded view of FIGS. 6 and 7, as well as in isolation in FIGS. 8 and 9, and it will be appreciated that the second end section 112 has substantially the same structure mirrored along a central line of the nozzle assembly 100.

The first end section 110 has a first portion 130 and a second portion 132. The first portion 130 comprises a generally rigid body with an aperture 134 formed therein. The aperture 134 receives a flexible duct 136 that acts as part of an air inlet of the nozzle assembly 100. The aperture 134 is located toward an outer side of the first portion 130, i.e. a side of the first portion 130 that is further from the face of a wearer when the nozzle assembly 100 is attached to the headgear 12 and the head wearable air purifier 10 is worn by the wearer.

A first, upper, side 137 of the first portion 130 comprises an opening 138 for receiving a corresponding upper pin 140 of the midsection 102, and similarly a second, lower, side 142 of the first portion 130 comprises an opening (not shown) for receiving a corresponding lower pin 144 of the midsection 102. Collectively the openings 138 and the upper and lower pins 140,144 act as hinges that enable relative pivoting between the first portion 130 and the midsection 102 about a first pivot axis A defined by the upper and lower pins 140,144. As will be appreciated from the figures, when the nozzle assembly 100 is located in front of a face of a wearer in use, the first pivot axis A extends in a generally vertical direction, such that rotation of the midsection 102 relative to the first portion 130 and the first end section 110 is enabled in a plane substantially parallel to a transverse plane of the wearer of the head wearable air purifier 10. Pivoting both inwardly and outwardly relative to a midline of the nozzle assembly 100 is enabled.

An inner side of the first portion 130, in a region adjacent the aperture 134, comprises a first connection formation 146 for connecting to a corresponding second connection formation 147 of the second portion 132. Details of the first connection formation 146 can be seen more clearly in FIG. 8. The first connection formation 146 comprises a generally cylindrical body extending rearwardly toward the second portion 132. The cylindrical body has an annular channel 148, and first and second side channels 150 (with only the second side channel 150 shown in FIG. 8, but the first side channel 150 having substantially the same form as the second side channel 150 but located on an opposing side of the cylindrical body). An edge of the annular channel 148 defines a lip 152 of the cylindrical body. The first and second side channels 150 extend partially about the circumference of the cylindrical body, with only the second side channel 150 visible in the figures.

The second portion 132 is formed of first 154 and second 156 parts. The first part 154 comprises a generally rigid body having an aperture 158 through which the flexible duct 136 extends when the nozzle assembly 100 is assembled. The first part 154 further comprises a first half 160 of the second connection formation 147, a magnetic detent 162 and a magnetic hinge 164.

The first half 160 of the second connection formation 147 comprises upper and lower projections 166 and a side projection 168. The upper and lower projections 166 are shaped to extend over the lip 152 of the cylindrical body of the first connection formation 146 of the first portion 130, and into the annular channel 148. The side projection 168 is configured to sit within the first side channel 150 of the first connection formation 146 of the first portion 130, but the side projection 168 has dimensions smaller than an extent of the first side channel 150 such that the side projection 168 is movable within the first side channel 150. Given the relative positioning of the annular channel 148 and the first side channel 150, it will be appreciated that the side projection 168 has a greater depth than the upper and lower projections 166.

The second part 156 of the second portion 132 comprises a generally rigid body shaped to correspond to the generally rigid body of the first part 154, such that the first 154 and second 156 parts mate. The second part 156 is connected to the first part 154 by screws and/or other appropriate fixings (not shown) when assembled.

The second part 156 comprises a second half 170 of the second connection formation 147, and the second half 170 of the second connection formation 147 comprises upper and lower projections 172 and a side projection 174, similar to the structure of the first half 160 of the second connection formation 147. The upper and lower projections 172 are shaped to extend over the lip 152 of the cylindrical body of the first connection formation 146 of the first portion 130, and into the annular channel 148. The side projection 174 is configured to sit within the second side channel 150 of the first connection formation 146 of the first portion 130, but the side projection 174 has dimensions smaller than an extent of the second side channel 150 such that the side projection 174 is movable within the second side channel 150. Given the relative positioning of the annular channel 148 and the second side channel 150, it will be appreciated that the side projection 174 has a greater depth than the upper and lower projections 172.

From the discussion above, and from FIGS. 5 to 9, it can be seen that, when assembled, the second portion 132 of the first end section 110 is connected to the first portion 130 of the first end section 110 by engagement of the first 146 and second 147 connection formations. Given the location of the upper and lower projections 166,172 within the annular channel 148, and the location of the side projections 168,174 within the respective first and second side channels 150, whilst the side projections 168,174 have smaller dimensions than the extent of the first and second side channels, relative rotation of the second portion 132 of the first end section 110 to the first portion 130 of the first end section 110 is enabled.

Thus it can be said that the second portion 132 of the first end section 110 is pivotally connected to the first portion 130 of the first end section 110 about a second pivot axis B, with the second pivot axis B defined by a central axis of the generally cylindrical body of the first connection formation 146. As will be appreciated from the discussion herein, and from FIGS. 5 to 9, the second pivot axis B enables relative rotation of the second portion 132 to the first portion 130 in a plane substantially parallel to a coronal plane of a wearer of the head wearable air purifier in use, with the second pivot axis B substantially orthogonal to the first pivot axis A.

The extent of the first and second side channels 150 limits relative rotation of the second portion 132 relative to the first portion to a range of no more than 20 degrees, or in some examples to a range of no more than 10 degrees. This may avoid placing torsional strain on the flexible duct 136, and may reduce the risk of a constriction of the flexible duct 136 in use.

The first pivot axis A and the second pivot axis B may enable movement of components of the nozzle assembly 100 in two different directions, which may provide increased flexibility relative to an arrangement where the first and second pivot axes are substantially parallel to one another. The nozzle assembly 100 may thereby provide increased flexibility and user comfort, enabling the nozzle assembly to be comfortably used for a variety of different head shapes and dimensions.

The second part 156 of the second portion 132 further comprises an aperture 176 through which the magnetic detent 162 of the first part 154 extends when the first part 154 is connected to the second part 156. The magnetic detent 162 cooperates with an upper magnet 124 on the first purifier assembly housing 14 to retain the nozzle assembly 100 relative to the first purifier assembly housing 14.

The magnetic hinge 164 comprises a central portion 178 and a carrier portion 180 pivotally connected to the central portion 178, with first 182 and second 184 magnets held within the carrier portion 180. The first 182 and second 184 magnets cooperate with corresponding lower magnets 126 on the first purifier assembly housing 14 to releasably connect the first end section 110, and hence the nozzle assembly 100, to the first purifier assembly housing 14. As the carrier portion 180 is pivotally connected to the central portion 178, the second portion 132, and hence the first end section 110, is pivotally connected to the first purifier assembly housing 14, and hence to the headgear 12. The lower magnets 126 on the first purifier assembly housing are spaced either side of a recess 127 which accommodates the central portion 178 of the magnetic hinge 164, and the lower magnets 126 are of different polarities, with the first 182 and second 184 magnets also of different polarities to enable the appropriate magnetic connection. This has been found to aid with connection of the nozzle assembly 100 to the headgear 12.

The second portion 132 of the first end section 110 is pivotally connected to the first purifier assembly housing 14 about a third pivot axis C defined by a rotation axis of the carrier portion 180, with the third pivot axis C substantially orthogonal to both the first pivot axis A, and a the second pivot axis B. As will be appreciated from the discussion herein, and from FIGS. 5 to 9, the third pivot axis C enables relative rotation of the second portion 132 to the first purifier assembly housing 14 in a plane substantially parallel to a sagittal plane of a wearer of the head wearable air purifier 10 in use. The pivotal connection of the second portion 132 to the first purifier assembly housing 14 allows the nozzle assembly 100 to be dipped relative to the first purifier assembly housing 14, for example with a wearer able to manually rotate the nozzle assembly 100 about the magnetic hinge 164, against and overcoming the force of attraction between the magnetic detent 162 and the upper magnet 124, such that the nozzle assembly 100 rotates downwardly relative to the wearer (ie in a plane parallel to a sagittal plane of a wearer), by no more than 60 degrees, or no more than 40 degrees.

As noted above, the second end section 112 has substantially the same structure as the first end section 110, albeit mirrored along a central line of the nozzle assembly 100, and so the second end section 112 will not be described in detail here for the sake of brevity, save for the following.

The second end section 112 has a first portion 186 and a second portion 188. The first portion 186 is pivotally connected to the midsection 102 about a fourth pivot axis, with the fourth pivot axis substantially parallel to the first pivot axis A. The fourth pivot axis enables relative rotation of the midsection 102 to the second end section 112 in a plane substantially parallel to a transverse plane of a wearer of the head wearable air purifier 10 in use.

The second portion 188 is pivotally connected to the first portion 186 about a fifth pivot axis, with the fifth pivot axis substantially orthogonal to the fourth pivot axis, and substantially parallel to the second pivot axis B. The fifth pivot axis enables relative rotation of the second portion 188 to the first portion 186 in a plane substantially parallel to a coronal plane of a wearer of the head wearable air purifier 10 in use.

The second portion 188 is pivotally connected to the second purifier assembly housing 16 via a magnetic hinge 190, about a sixth pivot axis, with the sixth pivot axis substantially orthogonal to both the fourth pivot axis and the fifth pivot axis. The sixth pivot axis enables rotation of the second portion 188 relative to the second purifier assembly housing 16 in a plane substantially parallel to a sagittal plane of a wearer of the head wearable air purifier 10 in use.

Thus the second end section 112 of the nozzle assembly 100 may offer similar motion to the first end section 110 of the nozzle assembly 100.

In use, the head wearable air purifier 10 is located on a head of a wearer such that the first 14 and second 16 air purifier assemblies are located over respective ears of the wearer, and the nozzle assembly 100 extends in front of a mouth and lower nasal region of the face of the wearer, without contacting the face of the wearer. The airflow generators 44 are actuable to draw air through the ambient air inlet 40 of each of the first 14 and second 16 purifier assembly housings, through the filter assemblies 42, and expel filtered airflow through the outlet apertures 43 into the flexible ducts 136 and through the first 110 and second 112 end sections toward the midsection 102. Filtered airflow travels through the midsection 102 as first and second filtered airflows, and is delivered from the nozzle assembly 100, via the air outlet 120, to the wearer of the head wearable air purifier 10. The speaker assemblies 32 may provide audio data to a user, for example in the form of music and the like, and alternatively or additionally may provide noise cancellation for noise caused by operation of the airflow generators 44.

Although depicted here with two airflow generators 44, each feeding one end of the nozzle assembly 100, it will be appreciated that in alternative embodiments only a single airflow generator 44 may be provided, which may either feed both or one of the ends of the nozzle assembly 100.

1. A head wearable air purifier comprising:
a headgear;
an air purifier assembly supported by the headgear, the air purifier assembly comprising a filter and an airflow generator for generating an airflow through the filter; and
a nozzle assembly comprising an inlet aperture configured to receive a filtered airflow from the air purifier assembly, and an air outlet for emitting the filtered airflow from the nozzle assembly;
wherein the nozzle assembly comprises a first end section connected to the headgear, a second end section connected to the headgear, and a midsection connected to the first end section and the second end section, the first end section comprises a first portion pivotally connected to the midsection about a first pivot axis, and a second portion pivotally connected to the first portion about a second pivot axis substantially orthogonal to the first pivot axis, the second portion connected to the headgear.

2. The head wearable air purifier as claimed in claim 1, wherein the first portion is pivotally connected to the midsection such that rotation of the midsection relative to the first end section is enabled in a plane substantially parallel to a transverse plane of a wearer of the head wearable air purifier in use.

3. The head wearable air purifier as claimed in claim 1, wherein the first portion is pivotally connected to the midsection such that internal and external rotation of the midsection relative to a midline of the headgear is enabled.

4. The head wearable air purifier as claimed in claim 1, wherein the second portion is pivotally connected to the first portion such that rotation of the second portion relative to the first portion is enabled in a plane substantially parallel to a coronal plane of a wearer of the head wearable air purifier in use.

5. The head wearable air purifier as claimed in claim 4, wherein the second portion is rotatable through a range of no more than 20 degrees relative to the first portion.

6. The head wearable air purifier as claimed in claim 1, wherein the second portion is pivotally connected to the headgear.

7. The head wearable air purifier as claimed in claim 6, wherein the second portion is pivotally connected to the headgear about a third pivot axis substantially orthogonal to the first pivot axis and substantially orthogonal to the second pivot axis.

8. The head wearable air purifier as claimed in claim 6, wherein the second portion is pivotally connected to the headgear such that rotation of the second portion relative to the headgear is enabled in a plane substantially parallel to a sagittal plane of a wearer of the head wearable air purifier in use.

9. The head wearable air purifier as claimed in claim 1, wherein the second portion is releasably connected to the headgear.

10. The head wearable air purifier as claimed in claim 1, wherein the second end section comprises a first portion pivotally connected to the midsection about a fourth pivot axis, and a second portion pivotally connected to the first portion about a fifth pivot axis substantially orthogonal to the fourth pivot axis, the second portion of the second end section connected to the headgear.

11. The head wearable air purifier as claimed in claim 10, wherein the first portion of the first end section is pivotally connected to the midsection such that rotation of the midsection relative to the first end section is enabled in a plane substantially parallel to a transverse plane of a wearer of the head wearable air purifier in use, and the first portion of the second end section is pivotally connected to the midsection such that rotation of the midsection relative to the second end section is enabled in substantially the same plane as rotation of the midsection relative to the first end section.

12. The head wearable air purifier as claimed in claim 10, wherein the second portion of the first end section is pivotally connected to the first portion of the first end section such that rotation of the second portion of the first end section relative to the first portion of the first end section is enabled in a plane substantially parallel to a coronal plane of a wearer of the head wearable air purifier in use, and the second portion of the second end section is pivotally connected to the first portion of the second end section such that rotation of the second portion of the second end section relative to the first portion of the second end section is enabled in substantially the same plane as rotation of the second portion of the first end section relative to the first portion of the first end section.

13. The head wearable air purifier as claimed in claim 12, wherein the second portion of the second end section is rotatable through a range of no more than 20 degrees relative to the first portion of the second end section.

14. The head wearable air purifier as claimed in claim 10, wherein the second portion of the second end section is pivotally connected to the headgear.

15. The head wearable air purifier as claimed in claim 14, wherein the second portion of the second end section is pivotally connected to the headgear about a sixth pivot axis substantially orthogonal to the fourth pivot axis and substantially orthogonal to the fifth pivot axis.

16. The head wearable air purifier as claimed in claim 1, wherein the second portion of the second end section is releasably connected to the headgear.

17. The head wearable air purifier as claimed in claim 1, wherein one of the first and second portions of the first end section comprises a channel that receives a corresponding projection of the other of the second and first portions of the first end section such that the projection is slidable within the channel to cause relative rotation between the first and second portions of the first end section, and an extent of the channel limits relative rotation between the first and second portions of the first end section.

18. The head wearable air purifier as claimed in claim 1, wherein the airflow generator and filter are configured to provide filtered airflow to the first end section of the nozzle assembly in use.

19. The head wearable air purifier as claimed in claim 18, wherein the air purifier assembly comprises a further airflow generator and a further filter configured to provide a further filtered airflow to the second end section of the nozzle assembly in use.

20. A nozzle assembly for a head wearable air purifier, the nozzle assembly comprising an inlet aperture for receiving an airflow, an air outlet for emitting the airflow from the nozzle assembly, a first end section for connection to a headgear, a second end section for connection to a headgear, and a midsection connected to the first end section and the second end section, the first end section comprises a first portion pivotally connected to the midsection about a first pivot axis, and a second portion pivotally connected to the first portion about a second pivot axis substantially orthogonal to the first pivot axis, the second portion for connection to the headgear.
